(19) United States
(12) Patent Application Publication
(10) Pub. No.: US 2026/0365493 A1
(43) Pub. Date: Nov. 19, 2026

(54) LOAD SUSPENSION DEVICE AND LIFTING DEVICE

(71) Applicant: Ludwig System GmbH & Co. KG, Bad Reichenhall (DE)

(72) Inventors: Peter WIMMER, Pfarrwerfen (AT); Peter RUF, Bad Reichenhall (DE)

(21) Appl. No.: 19/678,545

(22) Filed: May 15, 2026

(30) Foreign Application Priority Data
May 15, 2025 (DE) 102025118851.3

(51) Int. Cl. B66C 1/66

(52) U.S. Cl. CPC B66C 1/66; B66C 1/666

(57) ABSTRACT

Disclosed is a load suspension device, and a lifting device including at least one load suspension device, which is configured for attachment to a carrying means and for coupling to an anchor head. The load suspension device includes two gripping elements, a base body, a drive device and an adjustment device. The two gripping elements are configured for gripping the anchor head. The drive device is attached to the base body. The adjustment device is arranged to act between the drive device and at least one of the two gripping elements. At least one of the two gripping elements is adjustable using the drive device via the adjustment device relative to the respective other of the two gripping elements between a release position and a coupling position. In the release position, the anchor head is released. In the coupling position, the gripping elements are coupled to the anchor head.

### CROSS-REFERENCE TO RELATED APPLICATIONS

This application claims priority to DE 10 2025 118 851.3 filed May 15, 2025, the contents of which are hereby incorporated by reference herein in their entireties for all purposes.

### TECHNICAL FIELD OF THE INVENTION

The invention relates to a load suspension device, preferably an anchor head gripping device. Furthermore, the invention relates to a lifting device comprising at least one load suspension device.

### BACKGROUND OF THE INVENTION

In the field of lifting technology, for example in the construction industry and/or in timber construction and/or in the field of industrial applications, suspending and detaching processes of loads are one of the predominantly manually performed operations. In technical jargon, suspending loads is also referred to as rigging and detaching loads is also referred to as unrigging. For example, the term rigging can therefore refer to fastening the load to a crane (e.g. by connecting a rigging point of the load to a crane hook or rigging means fastened to the crane, such as chain slings). Unrigging can refer to the detachment of the load from a crane (e.g. by disconnecting a crane hook or rigging means attached to a crane hook from a rigging point of the load). Three sub-processes can be included for both rigging and unrigging:

When rigging:
1. Bringing into position of a crane hook or rigging means located on the crane hook above the rigging points by the crane operator;
2. Getting to the rigging point by a person responsible for rigging (the so-called rigger)—often using ladders, lifting platforms, etc. ;
3. Connection of the crane hook and the rigging point by the rigger (rigging in the narrower sense).

When unrigging:
1. Positioning and setting down of the load-often by an interaction between the crane operator (rough positioning) and a person responsible for the unrigging (the so-called unrigger), e.g. by turning and guiding it precisely into position;
2. Reaching of the rigging point of the unrigger-often using ladders, lifting platforms, etc;
3. Disconnecting of the connection between the crane hook and the rigging point by the disconnector (the unrigging in the narrower sense).

The more difficult a rigging point is to access, i.e. the greater the dangers and the greater the time required, the greater the benefit of an automated solution can be.

In many cases, step 2 above is only possible by using ladders, lifting platforms, scaffolding, etc., which allow the unrigger to approach the rigging point safely, with the corresponding disadvantages in terms of technical effort.

So-called transport or spherical head anchor systems are widely used in the precast concrete and timber construction sectors, for example. Here, a “head” made of metal, for example, is received by a suitable “anchor”. In timber construction, the screw head also serves as the “head” for lifting. In the field of precast concrete elements, the head is provided at the end of a bolt, which is cast into the concrete and connects well with it due to its geometry. Such lifting anchors are not without controversy. If used incorrectly, the load can be accidentally released.

To attach such transport anchors to the rigging point, they must be inserted and screwed in from the correct side. The usual geometry of such transport anchors is not ideal for automated locking and releasing. This leads to an increased safety risk, as manual intervention is usually necessary, and to increased technical effort.

In concrete construction, the anchors often remain in the precast concrete component, as the bolt with head is usually processed such that the head is flush with the component, but in timber construction the screws used are often unscrewed, which can pose an additional safety risk and further increases the technical effort.

In this context, the document DE 32 33 819 C1 discloses a device for manipulating a precast reinforced concrete part with the aid of a lifting means with at least one load rope and a pick-up unit with intermediate carrying means. The precast reinforced concrete part comprises at least one transport anchor embedded in concrete. The load rope belongs to a crane with a crane cab and is connected to the lifting unit. The pulling means each guide to a clutch that can be placed on the anchor head of a transport anchor set in concrete in the precast reinforced concrete part. The receiving unit has an actuating device for the clutches. Each of the clutches can be placed on or removed from an anchor head of the transport anchor in a released position of the actuating device.

The document WO 2024/002444 A1 relates to a lifting fork for lifting a heavy element. In the orientation provided during lifting, a lifting gear comprises a horizontally disposed beam having a longitudinal extension between a first end point and a second end point, a first gripping mechanism and a second gripping mechanism. The first gripping mechanism is connected to the horizontally disposed carrier and comprises a first clutch configured to be switched between an engageable configuration for engaging a lifting anchor of a heavy member and a disengageable configuration for disengaging the lifting anchor. The lifting anchor comprises a shaft with a through-opening. Only the lower part of the shaft is embedded in the concrete body, such that the upper part with the through opening is exposed. A locking element can engage in the through-opening of the shaft.

Disadvantages of the solutions described in DE 32 33 819 C1 and WO 2024/002444 A1 are that they are technically comparatively complex and the anchor head is gripped on one side and can therefore come loose.

### DESCRIPTION OF THE INVENTION

The invention is therefore based on the objective of providing an improved load suspension device which overcomes the disadvantages of known solutions. In particular, it is an objective of the invention to provide a solution for the automated rigging and/or unrigging of loads which is characterized by a reduced technical effort, offers increased operational safety and/or in which the load suspension device cannot be opened under a load (e.g. a load which can realistically be assumed in practice).

This objective is achieved by a load suspension device and a lifting device according to the invention, and are explained in more detail in the following description with partial reference to the figures.

The load suspension device can, for example, be designed as an anchor head gripping device.

The load suspension device is configured for attachment to a carrying means and for coupling to an anchor head. The load suspension device comprises at least two gripping elements for gripping the anchor head, a base body, a drive device and an adjustment device.

The drive device is attached to the base body.

The adjustment device is preferably a lever mechanism. The adjustment device is arranged to act between the drive device and at least one gripping element of the two gripping elements. For example, the adjustment device can also be arranged to act between the drive device and the two gripping elements.

At least one gripping element of the two gripping elements is adjustable (e.g. movable) relative to the other of the two gripping elements between a release position and a coupling position by means of the drive device via the adjustment device. In the release position (hereinafter also referred to in part as the “open state” of the load suspension device or the gripping elements), the anchor head is released. In the coupling position (hereinafter also referred to in part as the “closed state” of the load suspension device or the gripping elements), the gripping elements are coupled to the anchor head (e.g. by the gripping elements gripping the anchor head).

One advantage may be that the anchor head can be coupled more securely to the gripping elements. In other words, the load suspension device cannot be opened by forces that can realistically be assumed in practice in the loaded state of the load suspension device, which can increase operational safety accordingly.

In addition, an automated rigging process and/or an automated unrigging process can be implemented. Although in many cases there will be visual contact with the anchor head and/or the rigging point when locking, the load suspension device can also function in cases without visual contact. This can reduce the technical effort and/or the safety risk for persons tasked with the rigging and/or unrigging.

Another advantage can be seen in the scalability of the load suspension device. The load suspension device can be designed for comparatively low loads, but also for comparatively high loads (e.g. line loads of up to 5.3 t) by varying the dimensions, for example, while maintaining essentially the same structure and dimensions.

Overall, the load suspension device proposed here can have advantages in terms of operational safety, technical complexity and/or weight.

The load suspension device can form a so-called load handling attachment (LAM). The load suspension device can be a device that is not part of the lifting means and can be connected to the carrying means of the lifting means (e.g. the lifting device) for receiving and releasing the load.

In addition, the load suspension device may advantageously comprise a comparatively low dead weight.

The drive device is preferably designed as an electric drive device. Alternatively, however, it is also conceivable that the drive device is designed as a hydraulic and/or pneumatic drive device (e.g. with a suitable internal or electrical power supply).

The gripping elements can be designed as forged parts, for example.

In principle, the load suspension device may also comprise further adjustable and/or non-adjustable gripping elements as disclosed herein. For example, it is conceivable that the load suspension device comprises three adjustable gripping elements which are coupled to the anchor head in the coupling position at positions distributed evenly around its circumference. In other words, the technique described herein is not limited to two gripping elements.

In one embodiment example, the at least one adjustable gripping element may be hinged to the base body of the load suspension device via a pivot point. In addition, the adjustment device may comprise at least one lever arm which is hinged to the drive device via a first lever arm joint and is hinged to the at least one adjustable gripping element via a second lever arm joint. The first lever arm joint can be linearly slidable relative to the base body via actuation of the drive device. The second lever arm joint can be configured to pivot the adjustable gripping elements about the pivot point.

It is conceivable, for example, that the first lever arm joint is guided in an elongated hole in the base body.

The first lever arm joint can comprise an axle that is guided in the elongated hole. In addition, the housing can comprise a housing cover that is detachably fastened to the housing. The housing cover can be arranged on the housing such that the first lever arm joint is accessible from the outside when the housing cover is detached from the housing. The first lever arm joint can be removable through the housing cover (e.g. by means of a release tool). This enables, for example, a device to be implemented that enables a mechanical opening of the gripping elements and/or release of the anchor head in an emergency. This can, for example, further increase operational safety.

In principle, however, it is also conceivable, for example, that the at least one adjustable gripping element can be adjusted between the release position and the coupling position by means of a rotationally actuatable mechanism. For example, a mechanism similar to a drill chuck in a drill is conceivable.

The anchor head can form a rigging point. The anchor head can be a component attached to the load, the geometry of which allows the crane hook or rigging points on the crane hook to be fastened to it. For example, the anchor head is a bolt head or screw head (e.g. widened in comparison to a shaft). The anchor head can be part of an anchor (e.g. a bolt or screw).

In one embodiment example, the adjustment device can be adjustable into a locking position in which an adjustment of the at least one adjustable gripping element from the coupling position into the release position is blocked. The adjustment device can be configured to be held in the locking position and/or adjusted into the locking position by a load application of the gripping elements when lifting a load connected to the anchor head.

A release of the anchor head from the load suspension device during the lifting process can thus be advantageously prevented, as the load suspension device can only be opened in the unloaded state.

The load suspension device and/or the gripping elements and/or the adjustment device can be designed as a so-called self-locking geometry. Advantageously, the locking mechanism of the load suspension device can continue to close under load instead of opening. Within the payload range of the rigging point, the rule can therefore apply: the greater the load, the stronger and more secure the locking and/or the coupling between the gripping elements and the anchor head. This can advantageously provide a backup in the safety concept. If the blocking of the energy supply described later (e.g. power cut-off) fails, this safety level still remains. The adjustment device and/or the gripping elements can therefore be designed such that they close rather than open as a result of a load and/or a pull.

In one embodiment example, the first lever arm joint may be arranged closer to the pivot point in the locking position than the second lever arm joint.

In other words, the adjustment device may be adjustable to an overextended position, namely the locking position. If the load suspension device comprises only one adjustable gripping element, the first lever arm joint can be arranged closer to the pivot point of the gripping element than the second lever arm joint. If the load suspension device comprises two adjustable gripping elements, the first lever arm joint can be arranged closer to an imaginary straight line (e.g. running through the centers of the pivot points) connecting the pivot points of the two adjustable gripping elements than the respective second lever arm joints. The pivot points can be arranged (e.g. horizontally) in alignment with one another.

In one embodiment example, at least one of the gripping elements may comprise a gripping jaw and/or a gripping finger and/or a gripping pincer. The gripping jaw and/or the gripping finger and/or the gripping pincer may comprise a free end which is angled (e.g. inwards and/or in the direction of a longitudinal central axis of the load suspension device) and which is coupled to the anchor head in the coupling position and/or grips the anchor head.

In one embodiment example, at least one of the gripping elements can comprise a gripping shell.

The gripping shell can be formed in a hollow spherical segment shape on an inner side facing the anchor head in the coupling position.

Alternatively or additionally, the gripping shell can be formed in a spherical segment shape on an outer side facing away from the anchor head in the coupling position.

At least one of the gripping elements can be designed as a spherical shell.

Alternatively or additionally, the gripping shell can comprise a free end (e.g. facing the anchor head). In the coupling position, (e.g. only) the free end can be coupled to the anchor head and/or gripping the anchor head. In other words, in the coupling position, the gripping shell can only abut against and/or contact the edge of the anchor, in particular the anchor head.

The gripping shell can advantageously enable that no torque is transmitted to the anchor head and/or that the anchor is not subjected to bending stress by the gripping shell. This can prevent the anchor head from breaking off, which can increase operational safety accordingly. In addition, the geometry of the gripping shell can make it suitable for gripping anchor heads of different designs.

At least one of the gripping elements can be shell-shaped, jaw-shaped or finger-shaped, at least in sections.

In one embodiment, the gripping elements can grip behind the anchor head in the coupling position and/or grip the anchor head in a form-fitting manner.

For example, it is conceivable that, in the coupling position, the gripping elements abut against an abutment surface of the anchor head facing the load.

The term “form-fitting” and/or “form fit” as used herein can be understood to mean that a relative movement of two components is blocked by design details. This can make it possible to create a form fit. The form fit can block movements in one or more directions.

Optionally, the gripping elements can abut against the anchor head over a circumferential area of the head of at least 50%, at least 60% or at least 70%.

In one embodiment example, both of the two gripping elements can be adjustable relative to the other of the two gripping elements between the release position and the coupling position by means of the drive device via the adjustment device. This can, for example, result in comparatively small travel distances for the gripping elements and/or make the load suspension device even more compact.

In one embodiment example, the at least one adjustable gripping element can be adjustable from the release position via the coupling position into an empty gripping position, wherein the gripping elements comprise a smaller distance to each other at their free ends in the empty gripping position than in the coupling position.

In one embodiment example, the load suspension device can comprise a sensor device (e.g. a light barrier), by means of which it is detectable that the at least one adjustable gripping element is in the empty gripping position.

In one embodiment example, the load suspension device can comprise a spring device which is arranged to act between the adjustment device and the at least one adjustable gripping element. The spring device can be configured to push the at least one adjustable gripping element from the coupling position into the empty gripping position. The spring device may, for example, comprise a resilient joint and/or a resilient joint coupling.

In other words, the spring device can be configured to push the at least one adjustable gripping element into the release position when the at least one adjustable gripping element moves from the release position via the coupling position, but there is no anchor head between the gripping elements.

The spring device can be configured to be compressed by the anchor head in such a way that the at least one adjustable gripping element moves into the coupling position.

For example, a lever arm elongated hole can be provided on the lever arm, in which the second lever arm joint (e.g. as a spring-loaded axle) is slidably supported. The spring device can, for example, be arranged to act between the second lever arm and the second lever arm joint. It is conceivable, for example, that the spring device is configured to displace the second lever arm joint in the lever arm elongated hole and to push the at least one adjustable gripping element from the coupling position into the empty gripping position in such a way.

When gripping an anchor head, the spring force can be overcome, causing the second lever arm joint (e.g. the spring-loaded axle) to complete a path that is detected and/or measured, for example by means of a switch (e.g. a microswitch).

In one embodiment example, the drive device can be configured as a linear drive (e.g. as a spindle drive), wherein the linear drive is configured to displace the adjustment device relative to the base body of the load suspension device.

In one embodiment example, the load suspension device can comprise a housing which forms an elongated (e.g. at least in sections and/or essentially cylindrical) outer shell of the load suspension device, wherein the drive device and/or the adjustment device and/or the gripping elements are arranged at least in sections within the housing. The housing can comprise a slim outer geometry (e.g. with relative size ratios in which a length is approximately a multiple greater than a cross-sectional dimension of the housing).

This can advantageously prevent catch traps on the outer geometry of the load suspension device. In the case of precast concrete elements, for example, there may also be parts of reinforcing bars near the anchor head (e.g. the rigging point), in the worst case with sharp protruding ends of metal rods. By means of the housing it can be enabled that the load suspension device does not hook into these after opening. In particular the geometry of the locking mechanism and/or itself can be designed such that, after releasing, a repeated, undesired locking can be prevented.

Advantageously, the housing can protect the internal components from damage. After opening, the load suspension device can hit the load or be pulled over it, including any reinforcing bars. The housing can provide protection against these impacts and friction.

The housing can comprise a hand grip area that can be used to manually position the load suspension device. Even if the load suspension device can preferably be positioned without manual intervention, such that it is also possible to position the load suspension device manually over the anchor head.

In one embodiment example, the load suspension device may comprise a rigging region (e.g. a load means attachment area and/or an eyelet) configured for attaching the carrying means, wherein the base body is adjustable relative to the rigging region from an unloaded position to a loaded position by a load application of the gripping elements when lifting a load connected to the anchor head. In the unloaded position, an energy supply (e.g. an electrical power supply and/or a hydraulic pressure and/or a pneumatic pressure) to the drive device can be enabled. In the loaded position, the energy supply (e.g. an electrical power supply and/or a hydraulic pressure and/or a pneumatic pressure) to the drive device can be blocked in order to prevent adjustment of the at least one adjustable gripping element under the load application.

For example, a spring unit can be arranged to act between the base body and the rigging region, which can be compressed by the load application and which pushes the unloaded base body into the unloaded position.

A weighing device can be arranged in the load suspension device (e.g. acting between the base body and the rigging region), which is configured to determine the weight of the load when lifting the load and optionally transmit it to a control device (e.g. for further use in a control process and/or for display to a user).

Preferably, the blocking of the energy supply (e.g. the electrical energy cut-off) relates only to the drive device. Thereby, for example, a control board should remain active, albeit with as little activity and/or consumption as possible.

In one embodiment example, the at least one adjustable gripping element can be adjustable relative to the other of the two gripping elements between the coupling position and the release position by means of the drive device via the adjustment device.

Alternatively or additionally, an adjustment of the at least one adjustable gripping element from the coupling position to the release position can be blocked and/or prevented under load application of the gripping elements.

Alternatively or additionally, an adjustment of the at least one adjustable gripping element from the coupling position into the release position under load application of the gripping elements can only be enabled in an unloaded state of the gripping elements.

Alternatively or additionally, the load suspension device may comprise a control device and a receiver unit, wherein the receiver unit is configured for wireless communication with a transmitter unit (e.g. a remote control) and the control device is configured to control the drive device in response to communication signals of the transmitter unit and/or in response to manual actuation of a button (e.g. a pushbutton) of the load suspension device.

The control device can be configured to send a control signal to the transmitter unit depending on the release position and/or coupling position and/or locking position detected by the sensor device. The transmitter unit can be configured to output a corresponding signal to a user via a corresponding output device (e.g. locking state of the load suspension device in the release position or in the coupling position; load state of the load suspension device: “loaded” or “unloaded”; range: “within range” or “out of range” for opening; battery level of the energy storage: in percent or in stages or “enough energy” or “not enough energy” for opening).

An advantage can be a further safety gain, as, for example, the release of the deposited load from the hook can be implemented by a transmitted signal from a remote control. This enables the load suspension device and/or the gripping elements to open (e.g. move into the release position) and release the load without a person having to approach the load and/or manually unrig the load.

Alternatively or additionally, the load suspension device may comprise an electrical energy storage, wherein the electrical energy storage is configured for supplying energy to the drive device. Optionally, the electrical energy storage has an electrical contact device (e.g. charging contacts) on the outside of the housing, which is configured for charging the electrical energy storage.

Alternatively or additionally, the electrical energy storage can be charged inductively. Electrical contact devices can be omitted.

For example, two types of charging can be made possible. On the one hand, “direct” and/or “stationary” charging is possible. The load suspension device can be placed in a special charging cradle that is connected to a power supply. The internal electrical energy storage (e.g. the battery) can be charged via the contact device. On the other hand, “indirect” and/or “mobile” charging is possible. A mobile rechargeable battery can be attached to the load suspension device. Similar to the principle of power banks, the charging energy can then be transferred from the mobile battery to the electrical energy storage in the load suspension device. The load suspension device can remain on the carrying means (e.g. on the hook or on a crossbeam) during charging.

Alternatively or additionally, the load suspension device can comprise a (e.g. electrical and/or pneumatic and/or hydraulic) connection device (e.g. outside of the housing) configured for connecting the drive device to an external power supply.

The load suspension device can therefore also be powered by a permanent energy supply (e.g. power supply).

Alternatively or additionally, the load suspension device may comprise at least one sensor device (e.g. at least one light barrier) which is designed to detect the release position, the coupling position and/or the locking position.

Alternatively or additionally, a status output unit (e.g. an LED light) can be attached to the housing. The status output unit can be controllable by means of a control device. The control device can be configured to control the status output unit such that the status output unit emits a warning signal (e.g. a red warning light) if the gripping elements are not completely in the coupling position and/or the adjustment device is not in the locking position. The control device can be configured to control the status output unit such that the status output unit outputs a normal operating signal (e.g. a green light) when the gripping elements are in the coupling position or are in the release position. The status output unit can be arranged on the housing such that the warning signal and/or the normal operating signal is visible as well as possible from a distance and from all directions.

According to a second general aspect of the invention, a lifting device is provided.

The lifting device may, for example, be in the form of a crane.

The lifting device comprises a carrying means (e.g. a carrying rope) and at least one load suspension device as disclosed herein. Preferably, the lifting device comprises four carrying means, to each of which a load suspension device as disclosed herein is attached.

However, the at least one load suspension device need not be part of the lifting device and/or the crane, but may also be provided separately.

The at least one load suspension device is attached to the carrying means. It is also conceivable, for example, that the lifting device comprises a traverse to which four carrying ropes are attached, wherein a load suspension device as disclosed herein is attached to each of the carrying ropes.

Optionally, the lifting device may comprise the load to which the anchor head is attached.

For example, it is conceivable that the load is a precast concrete element, such as a filigree ceiling, comprising four rigging points designed as anchor heads. However, the load can also comprise other shapes, such as concrete barriers, stairs, etc.

Another exemplary area of application is timber construction. The load can be a roof and ceiling element, for example, which comprises four rigging points designed as anchor heads. However, the load can also be a prefabricated wall, for example, with two rigging points designed as anchor heads.

Furthermore, the possible applications should not be limited to the number of rigging points. Such that, for example, a load with only one anchor head or with at least two anchor heads is also conceivable in principle.

The load suspension device as disclosed herein can be used, for example, on a construction site when rigging on a truck and/or when setting down in a structure. However, it is also conceivable that the load suspension device as disclosed herein is used after the load has been manufactured, for example when rigging in the production line and/or when setting down in the warehouse and/or directly onto a truck.

In addition, the lifting device may optionally comprise the transmitter unit (e.g., a remote control) as disclosed herein.

### BRIEF DESCRIPTION OF THE DRAWINGS

The preferred embodiments and features of the invention described above may be combined with each other as desired. Further details and advantages of the invention are described below with reference to the accompanying drawings. It shows:

FIG. 1 a schematic view of a load suspension device with an anchor head attached to a load according to an embodiment example in the release position (partial sectional view);

FIG. 2 a schematic view of a load suspension device from FIG. 1 in the coupling position (adjustment device in locking position; partial sectional view);

FIG. 3 a schematic view of a load suspension device from FIG. 1 in the empty gripping position (partial sectional view);

FIG. 4 a schematic view of a load suspension device with an anchor head attached to a load according to an embodiment example in the release position (adjustment device in locking position; partial sectional view);

FIG. 5 a schematic enlargement of a section of FIG. 4 (adjustment device in locking position; partial sectional view); and

FIG. 6 a schematic view of a lifting device according to an embodiment example.

Identical or functionally equivalent units or elements are marked with the same reference signs in the figures. For their explanation, reference is also made in part to the description of other embodiments and/or figures in order to avoid repetitions.

Loads 32 to be lifted, such as precast concrete components and/or filigree ceilings and/or wooden components, are often provided with anchors 16 anchored to the loads 32 (e.g. cast-in or screwed-in), the anchor heads 14 of which protrude from the load 32. These anchor heads 14 may provide rigging points for a lifting device 100 (see FIG. 6) to facilitate lifting of the loads 32.

Connecting the anchor heads 14 to a load rope of the lifting device 100 is usually done manually, which requires a responsible person to climb onto the load 32 to connect the load rope to the anchor heads 14. This can be dangerous and awkward for the person.

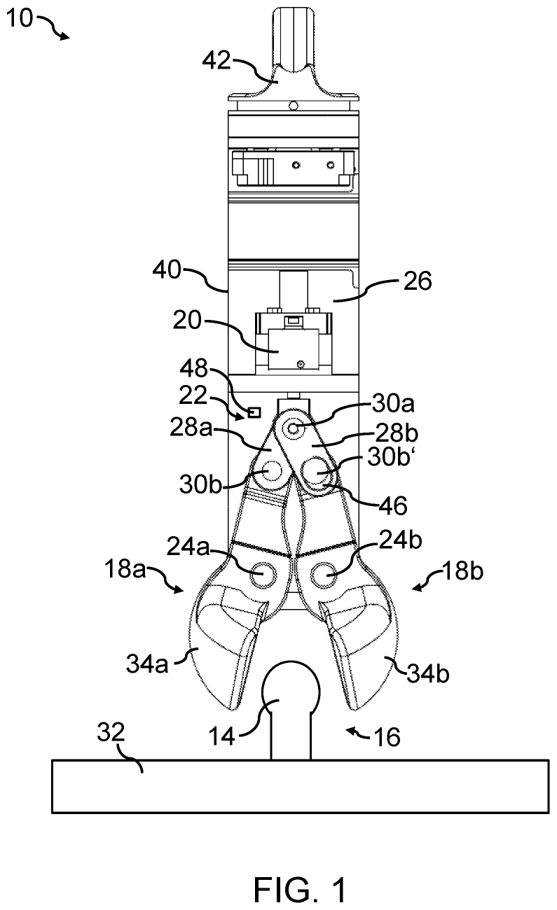

In this regard, a load suspension device 10 is provided, which is shown schematically in FIG. 1 in an embodiment example.

The load suspension device 10 comprises a rigging region 42 with an eyelet, via which the load suspension device 10 can be attached to a carrying means 12 of a lifting device 100, such as a crane.

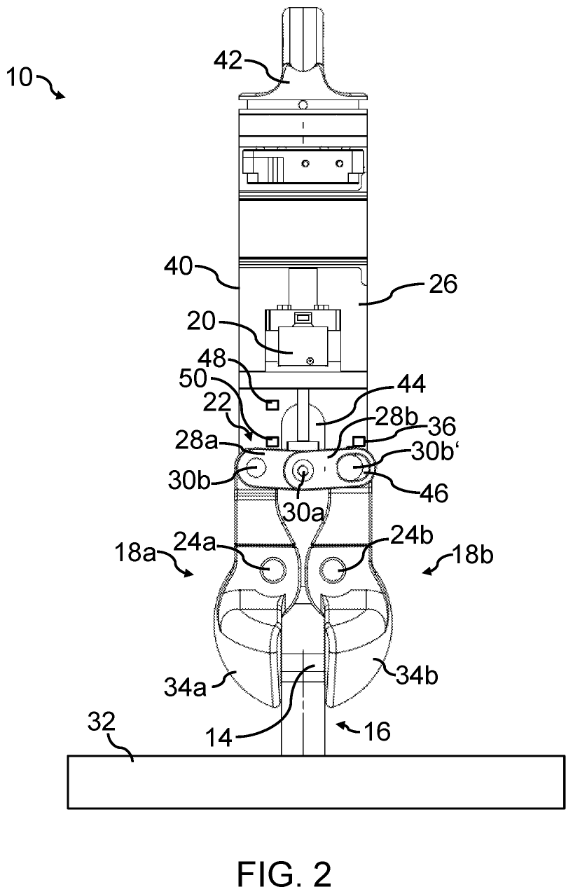

The load suspension device 10 is configured for coupling with an anchor head 14 of an anchor 16 connected to a load 32. For this purpose, the load suspension device 10 comprises at least two gripping elements 18a-b for gripping the anchor head 14, a drive device 20 and an adjustment device 22. At least one gripping element 18a-b of the two gripping elements 18a-b is adjustable (e.g. movable) between a release position and a coupling position relative to the other of the two gripping elements 18a-b. The following describes, by way of example only, an embodiment example with two adjustable gripping elements 18a-b. The gripping elements 18a-b of this embodiment are thus adjustable from the open release position (FIG. 1) relative to each other into the closed coupling position (FIG. 2) (and vice versa).

The lifting device 100 may optionally comprise a transmitter unit (e.g. a remote control) that communicates wirelessly with a receiver unit (not shown) of the load suspension device 10. A control device of the load suspension device 10 may be configured to control the drive device 20 in response to communication signals from the transmitter unit and/or in response to a manual actuation of a button (e.g. a push button) of the load suspension device 10.

In the release position shown as an example in FIG. 1, the anchor head 14 is released by the gripping elements 18a-b. The load suspension device 10 is thus released from the load 32. The gripping elements 18a-b are opened. It is conceivable, for example, that the load suspension device 10 is in a stand-by mode in which the remote control of the load suspension device 10 is disabled, for example by switching off a remote control.

In the release position, the load suspension device 10 can be positioned to the anchor head 10 when rigging the load 32 or can release this load 32 when the unrigging the load 32.

In the coupling position shown as an example in FIG. 2, the gripping elements 18a-b are coupled to the anchor head 14. The load suspension device 10 is therefore connected to the load 32 (e.g. via the anchor 16) and can be lifted. As will be described in detail later, the drive device 20 can be de-energized (e.g., electrically de-energized) by pulling the load, which places the load suspension device 10 in a safe state. At this point, an intentional opening or an opening caused by an incorrect opening command is not possible any more. After setting down the load 32, the load suspension device 10 is no longer under tension, which means that the energy supply (e.g. electrical power supply) for the drive device 10 can be restored. The user can now actuate a corresponding button on a remote control or a pushbutton on the load suspension device 10. This enables the load suspension device 10 to receive an opening command, which causes the gripping elements 18a-b to adjust to the release position and release the load 32.

To adjust the gripping elements 18a-b, the load suspension device 10 comprises the drive device 20 and the adjustment device 22 acting between the drive device 20 and the gripping elements 18a-b. The drive device 20 is fastened to a base body 26 of the load suspension device 10.

In the embodiment example shown, the gripping elements 18a-b are each pivotable about pivot points 24a-b relative to the base body 26 by means of the drive device 20 acting via the adjustment device 22.

The adjustment device 22 is exemplarily designed here as a lever mechanism. In the embodiment example shown, the adjustment device 22 comprises two lever arms 28a-b, each of which is hinged at the end side to the drive device via a common first lever arm joint 30a. The first lever arm joint 30a is guided axially displaceably in an elongated hole 44 of the base body 26. Each end side of the lever arms 28a-b comprises a second lever arm joint 30b, 30b′. The lever arm 28a is hinged to the gripping element 18a via its second lever arm joint 30b and is pivotably connected to the gripping element 18a. The lever arm 28b is hinged to the gripping element 18b via its second lever arm joint 30b′ and is pivotably connected to the gripping element 18b. By actuation of the drive device 20, the first lever arm joint 30a is linearly slidable in the elongated hole 44 relative to the base body 26. A displacement of the first lever arm joint 30a from the position shown in FIG. 1 in the elongated hole 44 to the position shown in FIG. 2 pushes the second lever arm joints 30b, 30b′ outwards, which leads to a pivoting of the gripping elements 18a-b about their pivot points 24a-b. As a result, the gripping elements 18a-b are pivoted from the release position (FIG. 1) into the coupling position (FIG. 2).

In this embodiment example, the drive device 20 is designed as a linear drive, namely as a spindle drive.

The load suspension device 10 may comprise the aforementioned control device and a receiver unit (not shown), wherein the receiver unit is configured for wireless communication with a transmitter unit. The control device is configured to control the linear motor in response to communication signals from the transmitter unit. In addition, in this embodiment example, the load suspension device 10 comprises a housing 40 which forms an elongated outer shell of the load suspension device 10. The drive device 20 and the adjustment device 22 are arranged inside the housing 40. The gripping elements 18a-b protrude from an housing opening in the housing 40.

An externally accessible button (not shown) is arranged on the housing 40. The control device is configured to control the linear motor in response to a manual actuation of the button. In this embodiment example, both remote control and manual control of the load suspension device 10 is possible.

The load suspension device 10 may comprise a plurality of sensor devices 48, 50 by means of which the position of the first lever arm joint 30a in the elongated hole 44 can be detected. The sensor devices 48, 50 can, by way of example, be designed as light barriers. In the position shown in FIG. 1, the sensor device 48 designed as a light barrier can, for example, be closed, while the sensor device 50 designed as a light barrier is open. In the position shown in FIG. 2, the sensor device 48 designed as a light barrier can be open, for example, while the sensor device 50 designed as a light barrier is closed. It is conceivable that an energy supply to the drive device 20 is interrupted when the sensor device 50 designed as a light barrier is closed.

In order to prevent the load suspension device 10 from opening under load, the adjustment device 22 can be adjustable into a locking position (see, for example, FIGS. 2, 4 and 5). If the adjustment device 22 is in the locking position, the gripping elements 18a-b are not adjustable from the coupling position into the release position under load.

This can be implemented, for example, by holding the adjustment device 22 in the locking position when lifting a load 32 connected to the anchor head 14.

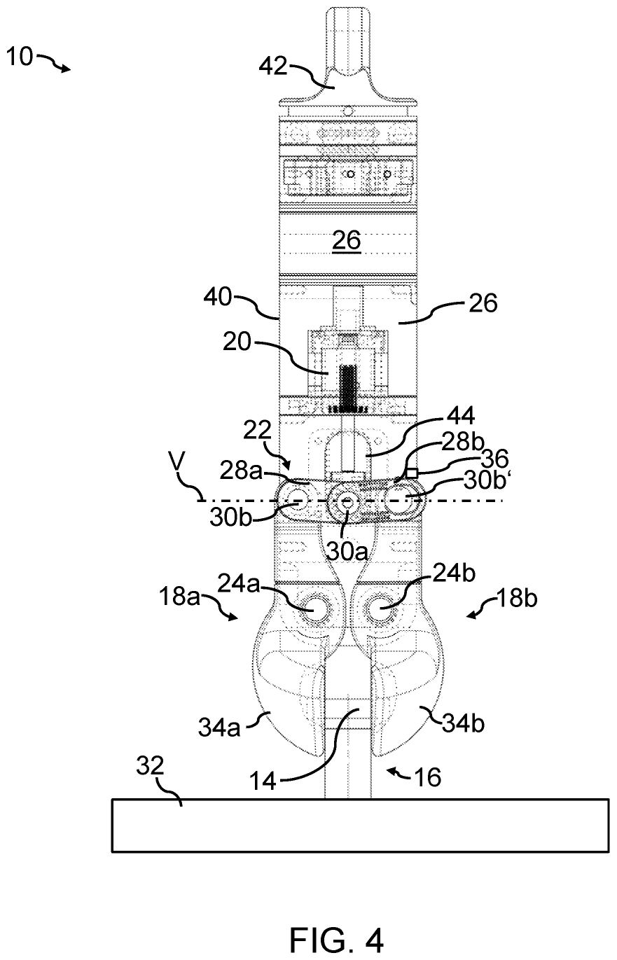

For this purpose, the adjustment device 22 can be moved into an overextended position, namely the locking position. For this purpose, the elongated hole 44 is dimensioned such that the first lever arm joint 30a is arranged closer to an imaginary straight connection line V of the pivot points (see FIG. 4) than the respective second lever arm joints 30b, 30b′ in the coupling position of the gripping elements 18a-b. A load application to the gripping elements 18a-b results in that the second lever arm joints 30b, 30b′ to be subjected to force relative to one another. The inclined lever arms 28a-b thereby push the first lever arm joint 30a against the (e.g. lower) end of the elongated hole 44 arranged closer to the pivot points 24a-b. Thus, the load application counteracts an opening of the gripping elements 18a-b. In other words, an adjustment of the at least one adjustable gripping element 18a-b from the coupling position to the release position under load application of the gripping elements 18a-b is blocked and/or prevented.

Each of the gripping elements 18a-b preferably comprises a gripping shell 34a-b. As can be seen in the figures, the gripping elements 18a-b may comprise a lever-like section extending between the lever arm joints 30a-b to the respective pivot point 24a-b. A section of the gripping elements 18a-b opposite the lever-like section in relation to the respective pivot point 24a-b can be formed as a gripping shell 34a-b.

The gripping shells 34a-b can be formed in a hollow spherical segment shape on an inner side facing the anchor head 14 in the coupling position. On an outer side facing away from the anchor head 14 in the coupling position, the gripping shells 34a-b can be formed in a spherical segment shape.

Preferably, the gripping shells 34a-b comprise a free end (e.g. facing the anchor head 14). In the coupling position, (e.g. only) the free end can be coupled to the anchor head 14.

Furthermore, it is preferred that the gripping shells 34a-b engage behind the anchor head 14 in the coupling position in a form-fitting manner.

A further aspect that can prevent the opening under load is implemented by means of a spring unit (not shown), which is arranged to act between the base body 26 and the rigging region 42. The base body 26 is adjustable from an unloaded position into a loaded position relative to the rigging region 42 by a load application of the gripping elements 18a-b when lifting the load 32 connected to the anchor head 14. In the unloaded position, an energy supply (e.g. an electrical power supply and/or a hydraulic pressure supply and/or a pneumatic pressure supply) to the drive device 20 is released. In the loaded position, the energy supply to the drive device 20 is blocked in order to prevent adjustment of the at least one adjustable gripping element 18a-b under the load application.

Whether the base body 26 is in the unloaded position or in the loaded position can be detected, for example, by means of suitable microswitches (e.g. two microswitches). These can be arranged at a suitable position in the housing 40. In the unloaded position, these can be open, for example, while in the loaded position they are closed, for example.

In one embodiment example, the load suspension device 10 can be configured to detect whether the gripping elements 18a-b have been moved out of the release position without gripping an anchor head 14.

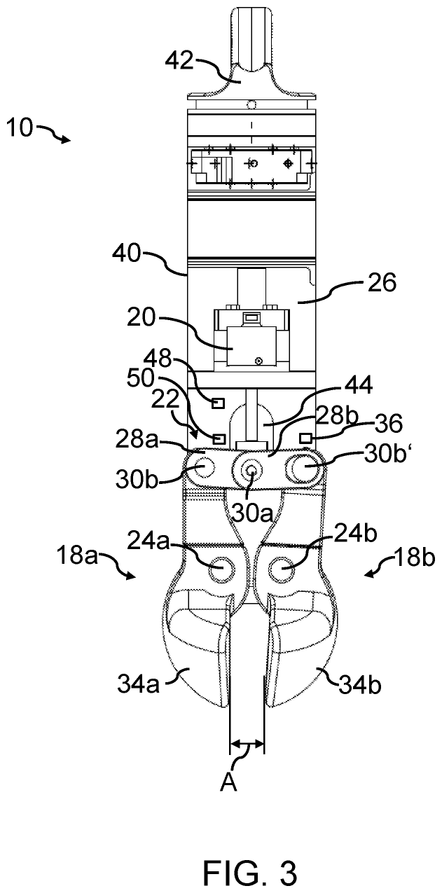

For this purpose, the gripping elements 18a-b are adjustable from the release position via the coupling position into an empty gripping position shown in FIG. 3. In the empty gripping position, the gripping elements 18a-b comprise a smaller distance A from each other at its free ends than in the coupling position.

As an example, this can be made possible by a spring device 38a-b (e.g. a resilient joint and/or a resilient joint coupling). The spring device 38a-b is arranged to act between the adjustment device 22 and the at least one adjustable gripping element 18a-b.

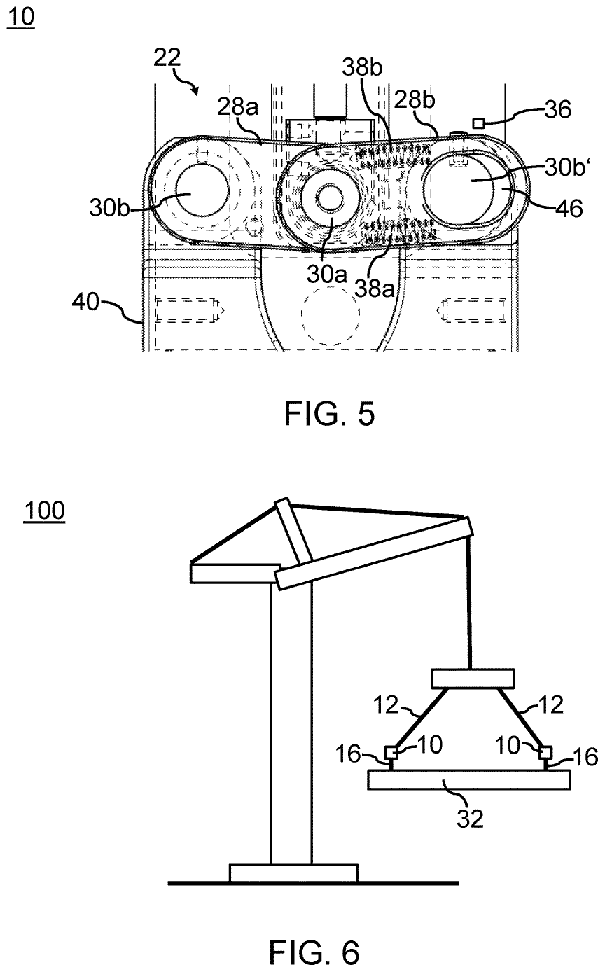

FIG. 5 shows an enlarged section of the spring device 38a-b from FIG. 4, in which some components are shown partially transparent for the sake of clarity.

A lever arm elongated hole 46 is provided on the lever arm 28b, here as an example, in which the second lever arm joint 30b′ of the lever arm 28b is supported in a displaceable manner. The spring device 38a-b can be arranged to act between the second lever arm 28b and the second lever arm joint 30b′. If there is no anchor head 14 between the gripping elements 18a-b moving from the release position via the coupling position, it is conceivable, for example, that the spring device 38a-b displaces the second lever arm joint 30b′ in the lever arm elongated hole 46 and pushes the adjustable gripping element 18b from the coupling position into the empty gripping position in such a way. The displacement of the second lever arm joint 30b′ in the lever arm slot 46 can be detected by a suitably suitable sensor device 36, which sends a corresponding warning signal to a control device. It is conceivable that a (e.g. visual) warning is then issued to a user of the load suspension device 10.

By way of example only, the sensor device 36 can be designed as a light barrier and can be closed in the empty gripping position of the gripping elements 18a-b shown in FIG. 3, while it is open in the coupling position shown in FIG. 2 and in the release position shown in FIG. 1.

As an example, the spring device 38a-b can comprise two compression springs.

As shown as an example in FIG. 6, the load suspension device 10 can be used in a lifting device 100.

The lifting device 100 can, for example, be designed as a crane.

In this embodiment example, the lifting device 100 comprises four carrying means 12 (e.g. four carrying ropes) and four load suspension devices 10 as disclosed herein, of which only two are visible in each case due to the two-dimensional representation. The load suspension devices 10 are each attached (for example, via the eyelet of their respective rigging region 42) to a carrying means 12.

Four anchors 16, each with an anchor head 14, are fastened (e.g. cast in) to the load 32, of which only two are also visible due to the two-dimensional representation.

In the illustration shown, the load suspension devices 10 are coupled to the four anchor heads 14. In the illustration shown, the load 32 is lifted by the lifting device 100 and can be moved to its destination.

Exemplary uses of the load suspension device 10 are described below.

A deposited load 32 is to be lifted by means of one or more load suspension devices 10 attached to a lifting device 100.

The load suspension device 10 is positioned (e.g. automatically or manually) such that the gripping elements 18a-b are located above the anchor head 14. Pressing the (e.g. push) button activates the drive device 20, which comprises a spindle drive. A spindle then causes the gripping elements 18a-b to move together via the adjustment device 22, which is designed as a lever mechanism. The drive device 20 moves the spindle until the sensor device 50 is closed, which triggers an interruption in the electrical power supply to the drive device 20.

When lifting a load 32 with the load suspension device 10, a pressure plate connected to it and spring-mounted with ball thrust pieces, for example, is pushed against a head plate (connected to the base body 40, for example) by pulling on the rigging region 42. If the load 32—by way of example only—is greater than 25 kg, the head plate moves by its entire travel of e.g. 1.5 mm and microswitches fastened to it are closed. The system is now de-energized. If, in this state, a signal is accidentally sent to open or actuate the button of the load suspension device 10, the system does not react in any way.

A release of the load 32 can only be permitted when the load suspension device 10 is de-energized. As soon as the load suspension device 20 is under tension, the electrical power supply to the opening mechanism and/or the drive device 20 can be switched off.

This makes it possible, for example, to reduce and/or prevent the negative effects of the following operating errors.

A user sends the signal to open the load suspension device 10 by means of the remote control while a load is suspended in the load suspension device 10 and being transported. The load suspension device 10 is under load, the drive device 20 is de-energized by closing the microswitches. The opening signal therefore has no effect and it is not possible to open the load suspension device 10.

The (e.g. push) button on the load suspension device 10 for opening the load suspension device 10 is actuated while a load 32 is suspended in the load suspension device 10 and is being transported. The load suspension device 10 is under load, the drive device 20 is de-energized by closing the microswitches. Thus, the opening signal has no effect and an opening of the load suspension device 10 is not possible.

The load 32 is suspended in the load suspension device 10, but is set down. The load suspension device 10 is therefore not under load and is therefore ready for operation. The remote control falls down onto the remote control buttons. The remote control buttons can have both a mechanical safety device (e.g. a housing ring) and a logical safety device (e.g. a two-button operation with time response). No opening signal is sent.

The invention is not limited to the embodiments described above. Rather, the invention also includes variants and modifications which also make use of the inventive concept and therefore fall within the scope of protection. In particular, the invention also claims protection for the subject matter and the features of the dependent claims independently of the claims referred to in each case and, in particular, also without the features of the main claim. The invention thus comprises various aspects of the invention which enjoy protection independently of each other.

### LIST OF REFERENCE SIGNS

10 Load suspension device
12 Carrying means
14 Anchor head
16 Anchor
18a-b Gripping elements
20 Drive device
22 Adjustment device
24a-b Pivot points
26 Base body
28a-b Lever arms
30a First lever arm joint
30b Second lever arm joint
30b′ Second lever arm joint
32 Load
34a-b Gripping shell
36 Sensor device
38a-b Spring device
40 Housing
42 Rigging region
44 Elongated hole
46 Lever arm slot
48 Sensor device
50 Sensor device
100 Lifting device
A Distance
V Connecting straight line

What is claimed is:

1. A load suspension device, which is configured for attachment to a carrying means and for coupling to an anchor head, wherein the load suspension device comprises:
two gripping elements configured for gripping the anchor head;
a base body;
a drive device which is attached to the base body; and
an adjustment device, wherein the adjustment device is arranged to act between the drive device and at least one gripping element of the two gripping elements,
characterized in that
the at least one gripping element of the two gripping elements is adjustable relative to the respective other of the two gripping elements by use of the drive device via the adjustment device between a release position, in which the anchor head is released, and a coupling position, in which the gripping elements are coupled to the anchor head.

2. The load suspension device according to claim 1, wherein
the at least one adjustable gripping element is hinged to the base body of the load suspension device via a pivot point; and
the adjustment device comprises at least one lever arm, which is hinged to the drive device via a first lever arm joint and is hinged to the at least one adjustable gripping element via a second lever arm joint, wherein the first lever arm joint is linearly slidable relative to the base body via actuation of the drive device and the second lever arm joint is configured to pivot the adjustable gripping element about the pivot point.

3. The load suspension device according to claim 1, wherein
the adjustment device is adjustable into a locking position, in which an adjustment of the at least one adjustable gripping element from the coupling position into the release position is blocked, wherein the adjustment device is configured to be held in the locking position and/or to be adjusted into the locking position by a load application of the gripping elements when lifting a load connected to the anchor head.

4. The load suspension device according to claim 2, wherein
the first lever arm joint is arranged closer to the pivot point in a locking position than the second lever arm joint.

5. The load suspension device according to claim 1, wherein at least one of the gripping elements comprises at least one of a gripping jaw, a gripping finger and a gripping pincer, wherein at least one of the gripping jaw and the gripping finger and the gripping pincer comprises an angled free end which is coupled to the anchor head in the coupling position.

6. The load suspension device according to claim 1, wherein at least one of the gripping elements comprises a gripping shell, comprising at least one of the features:
the gripping shell is formed in a shape of a hollow spherical segment on an inner side facing the anchor head in the coupling position; and
the gripping shell is formed in a shape of a spherical segment on an outer side facing away from the anchor head in the coupling position; and
in the coupling position, a free end of the gripping shell is coupled to the anchor head.

7. The load suspension device according to claim 1, wherein
the gripping elements engage behind the anchor head in the coupling position and/or grip the anchor head in a form-fitting manner.

8. The load suspension device according to claim 1, wherein
both of the two gripping elements are adjustable relative to the respective other of the two gripping elements between the release position and the coupling position by use of the drive device via the adjustment device.

9. The load suspension device according to claim 1, wherein
the at least one adjustable gripping element is adjustable from the release position via the coupling position into an empty gripping position, wherein the gripping elements comprise a smaller distance from each other at their free ends in the empty gripping position than in the coupling position.

10. The load suspension device according to claim 9, which comprises:
a sensor device by use of which it is detectable that the at least one adjustable gripping element is in the empty gripping position.

11. The load suspension device according to claim 9, which comprises:
a spring device, which is arranged to act between the adjustment device and the at least one adjustable gripping element and which is configured to push the at least one adjustable gripping element from the coupling position into the empty gripping position.

12. The load suspension device according to claim 1, wherein
the drive device is configured as a linear drive, wherein the linear drive is configured to displace the adjustment device relative to the base body of the load suspension device.

13. The load suspension device according to claim 1, which comprises:
a housing, which forms an elongated outer shell of the load suspension device, wherein at least one of the drive device and the adjustment device and the gripping elements are arranged at least in sections inside the housing.

14. The load suspension device according to claim 1, which comprises:
a rigging region, which is configured for attaching the carrying means, wherein the base body is adjustable relative to the rigging region from an unloaded position into a loaded position by a load application of the gripping elements when lifting a load connected to the anchor head, wherein in the unloaded position an energy supply to the drive device is enabled and in the loaded position the energy supply to the drive device is blocked in order to prevent an adjustment of the at least one adjustable gripping element under the load application.

15. The load suspension device according to claim 1, comprising at least one of the features:
the at least one adjustable gripping element is adjustable relative to the respective other of the two gripping elements by use of the drive device via the adjustment device between the coupling position into the release position; and
an adjustment of the at least one adjustable gripping element from the coupling position into the release position is blocked and/or prevented under load application of the gripping elements; and
an adjustment of the at least one adjustable gripping element from the coupling position into the release position under load application of the gripping elements is only enabled in an unloaded state of the gripping elements; and
the load suspension device comprises a control device and a receiver unit, wherein the receiver unit is configured for wireless communication with a transmitter unit and the control device is configured to control the drive device in response to communication signals of the transmitter unit and/or in response to a manual actuation of a button of the load suspension device; and
the load suspension device comprises an electrical energy storage, wherein the electrical energy storage is configured for supplying energy to the drive device; and
the load suspension device comprises a connection device, which is configured for connecting the drive device to an external power supply; and
the load suspension device comprises at least one sensor device, which is designed to detect the release position, the coupling position and/or a locking position.

16. The load suspension device according to claim 1, wherein the load suspension device is anchor head gripping device.

17. The load suspension device according to claim 1, wherein the adjustment device is a lever mechanism.

18. The load suspension device according to claim 13, wherein the housing forms an at least in sections cylindrical outer shell of the load suspension device.

19. The load suspension device according to claim 15, wherein an electrical contact device is arranged outside of a housing, which is configured for charging the electrical energy storage, and/or the electrical energy storage is chargeable inductively.

20. The load suspension device according to claim 15, wherein the connection device is arranged outside of a housing.

21. A lifting device, comprising:
at least one carrying means; and
at least one load suspension device according to claim 1, which is attached to the at least one carrying means.

22. The lifting device according to claim 21, wherein the lifting device is a crane.

23. The lifting device according to claim 21, wherein the carrying means is a carrying rope.

24. The lifting device according to claim 21, wherein the lifting device comprises the load to which the anchor head is attached.
